(19) United States
(12) Patent Application Publication
(10) Pub. No.: US 2026/0149773 A1
(43) Pub. Date: May 28, 2026

(54) ACOUSTIC WAVE DEVICE, MULTI-FEED DETECTOR, AND ELECTRONIC APPARATUS

(71) Applicant: SEIKO EPSON CORPORATION, Tokyo (JP)

(72) Inventors: Chikara KOJIMA, MATSUMOTO-SHI (JP); Junichi KARASAWA, SHIMOSUWA-MCHI (JP); Motoki TAKABE, SHIOJIRI-SHI (JP)

(21) Appl. No.: 19/399,806

(22) Filed: Nov. 25, 2025

(30) Foreign Application Priority Data
Nov. 28, 2024 (JP) 2024-207641

(51) Int. Cl. H04N 1/00; G01H 11/08

(52) U.S. Cl. CPC H04N 1/00037; G01H 11/08; H04N 1/00018; H04N 1/00689; H04N 1/00729

(57) ABSTRACT

An acoustic wave device includes a base having a hollow, an acoustic wave element provided at a position corresponding to the hollow of the base and generating acoustic waves, and a cap provided on a surface of the base opposite to a surface on which the acoustic wave element is provided and closing the hollow, wherein the cap has a first surface facing the hollow and a second surface located on a side opposite to the hollow in a front and back relationship with each other, and a hole that opens to the first surface and extends toward the second surface, a width of the hole is smaller than a width of the acoustic wave element, and the hole does not penetrate the cap.

The present application is based on, and claims priority from JP Application Serial Number 2024-207641, filed November 28, 2024, the disclosure of which is hereby incorporated by reference herein in its entirety.

### BACKGROUND

### Technical Field

The present disclosure relates to an acoustic wave device, a multi-feed detector, and an electronic apparatus.

### Related Art

JP-A-2020-096306 discloses an image scanner as an electronic apparatus including a sensor unit including an ultrasonic device that transmits ultrasonic waves and an attachment object to which the sensor unit is attached.

The sensor unit includes a pair of ultrasonic devices. The ultrasonic waves are transmitted from one ultrasonic device, and the ultrasonic waves transmitted through a sheet are received by the other ultrasonic device. As a result, the sensor unit can detect multi-feed of sheets according to the sound pressure of the received ultrasonic waves.

The sensor unit described in JP-A-2020-096306 includes a mesh-like cap through which the ultrasonic waves transmitted from the ultrasonic device are transmitted. By providing the cap, it is possible to suppress entry of foreign matter such as paper dust falling off from the sheets into the ultrasonic device.

JP-A-2020-096306 is an example of the related art.

However, the sensor unit disclosed in JP-A-2020-096306 has a problem that the ultrasonic waves transmitted through the cap are attenuated. When the ultrasonic waves are attenuated, the accuracy of detecting multi-feed of the sheets is reduced. There is a similar problem in a device using acoustic waves other than ultrasonic waves.

Therefore, there is a demand for an acoustic wave device in which the entry of foreign matter can be suppressed and the transmitted and received acoustic waves are less likely to be attenuated.

### SUMMARY

An acoustic wave device according to an application example of the present disclosure includes a base having a hollow, an acoustic wave element provided at a position corresponding to the hollow of the base and generating acoustic waves, and a cap provided on a surface of the base opposite to a surface on which the acoustic wave element is provided and closing the hollow, wherein the cap has a first surface facing the hollow and a second surface located on a side opposite to the hollow in a front and back relationship with each other, and a hole that opens to the first surface and extends toward the second surface, a width of the hole is smaller than a width of the acoustic wave element, and the hole does not penetrate the cap.

A multi-feed detector according to an application example of the present disclosure includes a transmitter including the acoustic wave device according to the application example of the present disclosure and transmitting the ultrasonic waves, and a receiver including the acoustic wave device according to the application example of the present disclosure and receiving the ultrasonic waves, wherein the transmitter and the receiver are disposed with a conveyance path of a medium in between, and the ultrasonic waves are transmitted from the transmitter, the ultrasonic waves transmitted through the medium are received by the receiver, and multi-feed of the medium is detected based on signal intensity of a reception signal.

An electronic apparatus according to an application example of the present disclosure includes the acoustic wave device according to the application example of the present disclosure.

### BRIEF DESCRIPTION OF THE DRAWINGS

FIG. 1 is an external view showing a schematic configuration of an image scanner as an electronic apparatus according to a first embodiment.

FIG. 2 is a side sectional view schematically showing a conveyance unit of the image scanner shown in FIG. 1.

FIG. 3 is a cross-sectional view showing a schematic configuration of an ultrasonic sensor shown in FIG. 2.

FIG. 4 is a cross-sectional view showing a configuration of an acoustic wave device in FIG. 3.

FIG. 5 is a partially enlarged view of FIG. 4.

FIG. 6 is a plan view of the acoustic wave device shown in FIG. 4.

FIG. 7 shows a result of a simulation of propagation of ultrasonic waves in a hollow of the acoustic wave device and a space S located in a Z direction thereof.

FIG. 8 shows a result of a simulation of propagation of ultrasonic waves in the hollow of the acoustic wave device and the space S located in the Z direction.

FIG. 9 shows a result of a simulation of propagation of ultrasonic waves in the hollow of the acoustic wave device and the space S located in the Z direction.

FIG. 10 is a cross-sectional view showing a modification of the acoustic wave device in FIG. 4.

FIG. 11 is a plan view of the acoustic wave device shown in FIG. 10.

FIG. 12 is a cross-sectional view showing a modification of the acoustic wave device in FIG. 4.

FIG. 13 is a plan view of the acoustic wave device shown in FIG. 12.

FIG. 14 is a cross-sectional view showing a modification of the acoustic wave device in FIG. 12.

FIG. 15 is an external view showing a schematic configuration of a wireless earphone as an electronic apparatus according to a second embodiment.

FIG. 16 is a partially enlarged cross-sectional view of FIG. 15.

FIG. 17 is an external view of the wireless earphone shown in FIG. 15 when viewed from an angle different from that in FIG. 15.

### DESCRIPTION OF EMBODIMENTS

Hereinafter, an acoustic wave device, a multi-feed detector, and an electronic apparatus according to the present disclosure will be described in detail based on embodiments shown in the accompanying drawings.

### First Embodiment

First, a first embodiment will be described.

### 1.1. Image Scanner

First, an image scanner will be described as an example of an electronic apparatus according to the first embodiment.

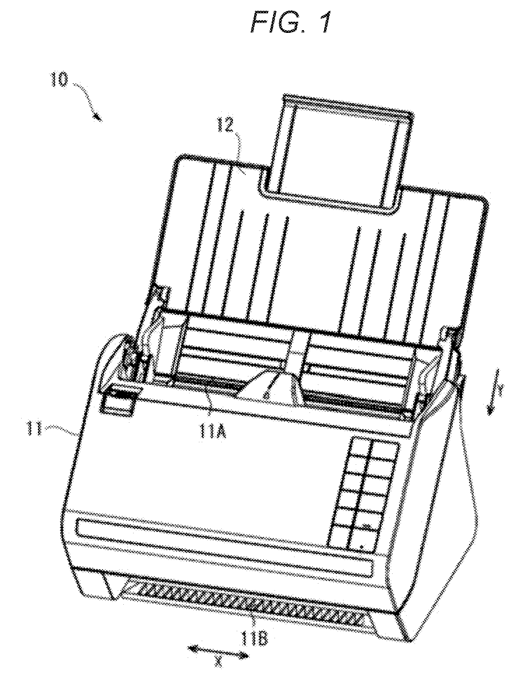

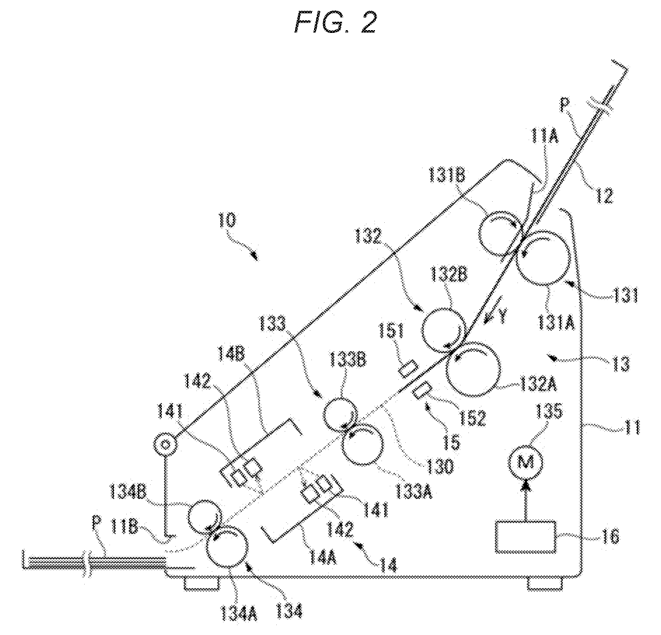

FIG. 1 is an external view showing a schematic configuration of an image scanner 10 as the electronic apparatus according to the first embodiment. FIG. 2 is a side sectional view schematically showing a conveyance unit of the image scanner 10 illustrated in FIG. 1. FIG. 2 is the side sectional view of the image scanner 10 when viewed from a main scanning direction (X direction) orthogonal to a conveyance direction (Y direction). In FIG. 2, the Y direction is indicated by an arrow, the pointer side of the arrow is referred to as a +Y side, and the tail side of the arrow is referred to as a -Y side.

### 1.1.1. Schematic Configuration of Image Scanner 10

The image scanner 10 illustrated in FIG. 1 includes an apparatus main body 11 and a sheet support 12. As illustrated in FIG. 2, a conveyance unit 13 that conveys a sheet P, a scanning unit 14 that reads an image of the conveyed sheet P, an ultrasonic sensor 15 that detects multi-feed of the sheets P, and a control unit 16 that controls the operation of the image scanner 10 are provided inside the apparatus main body 11. In the present embodiment, the sheet P is taken as an example of an object for which the ultrasonic sensor 15 detects multi-feed, but the object is not limited thereto. Examples of the object include a film, a fabric, and various media.

As shown in FIGS. 1 and 2, the apparatus main body 11 is provided with a feed port 11A at a coupling position to the sheet support 12. The sheets P placed on the sheet support 12 are fed one by one to the feed port 11A. The fed sheets P are conveyed by the conveyance unit 13 along a predetermined conveyance path 130 in the apparatus main body 11. The image is read by the scanning unit 14 at the reading position in the middle of the conveyance, and then the sheet is ejected from an ejection port 11B opened in the front lower portion of the apparatus main body 11.

### 1.1.2. Configuration of Conveyance Unit 13

The conveyance unit 13 illustrated in FIG. 2 conveys a plurality of sheets P set on the sheet support 12 one by one in the conveyance direction (Y direction). That is, the conveyance unit 13 guides and feeds the sheet P fed from the feeding port 11A into the apparatus main body 11, and conveys the fed sheet P along the predetermined conveyance path 130.

More specifically, the conveyance unit 13 includes a first feed roller pair 131 disposed upstream of the conveyance path 130 (at the -Y side) in the Y direction, and a second feed roller pair 132 disposed downstream of the first feed roller pair 131 (at the +Y side) in the Y direction. Further, the conveyance unit 13 includes a first conveyance roller pair 133 disposed at the -Y side and a second conveyance roller pair 134 disposed at the +Y side with the reading position of the sheet P in between.

The first feed roller pair 131 includes a first driving roller 131A and a first driven roller 131B. Similarly, the second feed roller pair 132 includes a second driving roller 132A and a second driven roller 132B. Further, the first conveyance roller pair 133 includes a third driving roller 133A and a third driven roller 133B. Similarly, the second conveyance roller pair 134 includes a fourth driving roller 134A and a fourth driven roller 134B. The driven rollers 131B to 134B are driven by rotation of the driving rollers 131A to 134A of the pairs, respectively.

Each of the driving rollers 131A to 134A forming each roller pair 131 to 134 is rotationally driven by power of a conveyance motor 135 as a power source thereof. The operation of the conveyance motor 135 is controlled by the control unit 16 to drive the driving rollers 131A to 134A.

The second driven roller 132B forming the second feed roller pair 132 is a retard roller, and the friction coefficient of the outer circumferential surface thereof with respect to the sheet P is larger than the friction coefficient of the outer circumferential surface of the second driving roller 132A with respect to the sheet P. Accordingly, the second feed roller pair 132 functions as a separation mechanism that separates the sheets P one by one and sends the sheets P to the +Y side. Therefore, the plurality of sheets P stacked on the sheet support 12 are fed by the rotation of the first feed roller pair 131 into the apparatus main body 11 from the feeding port 11A one by one in order from the uppermost sheet, for example, and are separated one by one and fed to the +Y side by the rotation of the second feed roller pair 132.

### 1.1.3. Configuration of Scanning Unit 14

As illustrated in FIG. 2, the scanning unit 14 is provided between the first conveyance roller pair 133 and the second conveyance roller pair 134 in the conveyance path 130.

The scanning unit 14 includes a first scanning unit 14A and a second scanning unit 14B provided on both sides with the conveyance path 130 in between. The scanning unit 14 includes a light source 141 capable of irradiating the sheet P being conveyed with light and an image sensor 142 extending in the main scanning direction (X direction). In a normal reading mode for reading the front surface of the sheet P, the first scanning unit 14A performs the reading operation, and in a double-sided reading mode for reading the front and back surfaces of the sheet P, both the first scanning unit 14A and the second scanning unit 14B perform the reading operation. Each of the first scanning unit 14A and the second scanning unit 14B includes the light source 141 and the image sensor 142. These units are coupled to the control unit 16 and perform scanning processing of reading an image on the sheet P under the control of the control unit 16.

### 1.1.4. Configuration of Ultrasonic Sensor 15

The ultrasonic sensor 15 is provided at a position between the second feed roller pair 132 and the first conveyance roller pair 133 in the conveyance path 130. The ultrasonic sensor 15 is a multi-feed sensor (a multi-feed detector according to the first embodiment), and detects multi-feed of the sheets P conveyed by the conveyance unit 13 by ultrasonic waves.

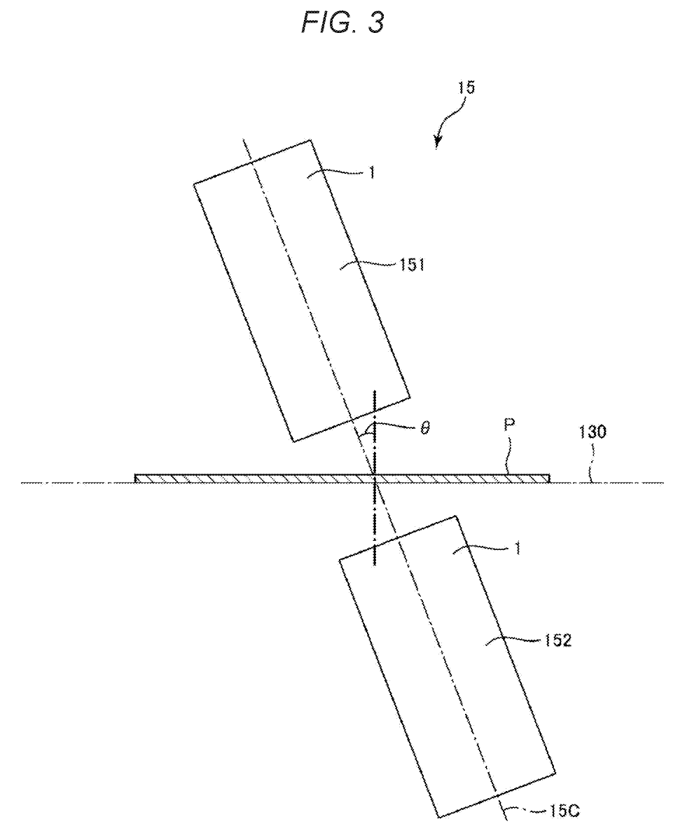

FIG. 3 is a cross-sectional view showing a schematic configuration of the ultrasonic sensor 15 shown in FIG. 2. FIG. 3 shows a cross section of the ultrasonic sensor 15 when viewed from the X direction.

The ultrasonic sensor 15 includes a transmitter 151 and a receiver 152. The transmitter 151 transmits ultrasonic waves having a high frequency among the acoustic waves. The receiver 152 receives the ultrasonic waves transmitted from the transmitter 151.

As illustrated in FIG. 3, the transmitter 151 and the receiver 152 face each other on a sensor central axis 15C, and are disposed with the conveyance path 130 through which the sheet P is conveyed in between. Note that the transmitter 151 and the receiver 152 may be disposed at positions where the units illustrated in FIG. 3 are replaced with each other.

The ultrasonic sensor 15 transmits ultrasonic waves from the transmitter 151 to the sheet P conveyed along the conveyance path 130 by the conveyance unit 13. The ultrasonic waves transmitted from the transmitter 151 are incident on the sheet P, and the ultrasonic waves transmitted through the sheet P are received by the receiver 152. When the ultrasonic waves are received by the receiver 152, a reception signal corresponding to sound pressure of the received ultrasonic waves is output from the receiver 152, and the multi-feed of the sheets P is detected based on signal intensity of the reception signal.

As shown in FIG. 3, the sensor central axis 15C is an axis passing through the center of the transmitter 151 and the center of the receiver 152, along which the ultrasonic waves are transmitted and received. In the present embodiment, the sensor central axis 15C is inclined at an angle θ with respect to the normal line of the surface of the sheet P conveyed in the conveyance path 130. By inclining the sensor central axis 15C with respect to the normal line of the surface of the sheet P, it is possible to reduce reception of unnecessary ultrasonic components such as multiply reflected ultrasonic waves and detect multi-feed with high accuracy.

The transmitter 151 and the receiver 152 each include the acoustic wave device 1 according to the first embodiment. Hereinafter, the configuration of the acoustic wave device 1 provided in the transmitter 151 will be described. Since the following description is also applicable to the acoustic wave device 1 provided in the receiver 152, the description of the configuration of the acoustic wave device 1 provided in the receiver 152 will be omitted. The acoustic wave device 1 is a device that transmits and receives acoustic waves, and the acoustic waves include, for example, ultrasonic waves, audible acoustic waves, and the like. Since ultrasonic waves are mainly used in the ultrasonic sensor 15, in the following description, the acoustic wave device 1 that particularly transmits and receives an ultrasonic range of acoustic waves will be described as an example. By using ultrasonic waves, for example, the acoustic wave device 1 capable of measuring a distance and detecting an object can be realized. The following description is also applicable to an acoustic wave device that transmits and receives audible acoustic waves.

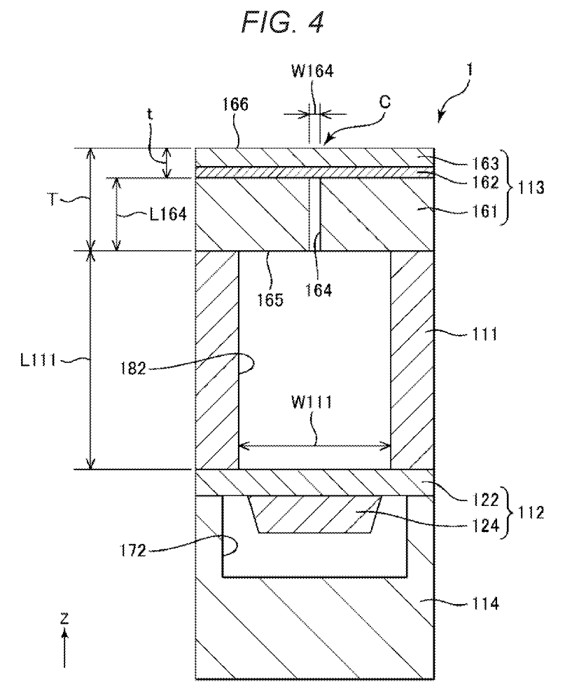

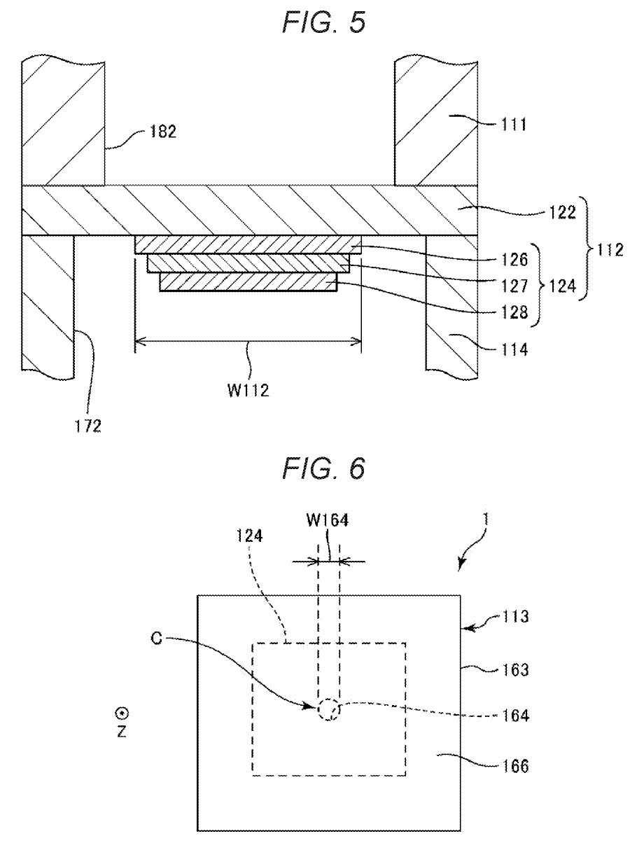

FIG. 4 is a cross-sectional view showing a configuration of the acoustic wave device 1 in FIG. 3. FIG. 4 shows a cross section including the sensor central axis 15C shown in FIG. 3. FIG. 5 is a partially enlarged view of FIG. 4. FIG. 6 is a plan view of the acoustic wave device 1 shown in FIG. 4. Note that FIG. 6 shows a plane viewed from the sheet P side shown in FIG. 3.

The acoustic wave device 1 shown in FIG. 4 includes a base 111, an ultrasonic element 112 (acoustic wave element), a cap 113, and a sealing substrate 114. The acoustic wave device 1 transmits ultrasonic waves in a Z direction indicated by an arrow in FIG. 4. The Z direction is parallel to the sensor central axis 15C.

### 1.1.4.1. Base

The base 111 has a hollow 182 penetrating along the Z direction. Examples of the constituent material of the base 111 include a silicon-based material such as Si, an oxide-based material such as SiOx (0 < x < 3) or ZrOx (0 < x < 3), and a resin-based material such as permanent resist. Among the materials, a silicon-based material is preferably used from the viewpoint of ease of production or the like, and Si is more preferably used.

A length L111 of the hollow 182 in the Z direction is set according to the frequency or the like of the ultrasonic waves transmitted by the acoustic wave device 1, but is not particularly limited. The length is preferably from 30 μm to 500 μm, and more preferably from 50 μm to 200 μm.

A width W111 of the hollow 182 in the direction orthogonal to the Z direction is set according to the frequency of the ultrasonic waves transmitted by the acoustic wave device 1, but is not particularly limited. The width is preferably from 50 μm to 3000 μm, and more preferably from 100 μm to 500 μm.

The ultrasonic element 112 is disposed at a side opposite to the Z direction of the base 111. As shown in FIG. 4, the ultrasonic element 112 is provided at a position corresponding to the hollow 182 of the base 111. That is, the ultrasonic element 112 closes the end of the hollow 182 opposite to the Z direction.

As illustrated in FIG. 4, the ultrasonic element 112 includes a diaphragm 122 and a piezoelectric element 124 provided on a surface of the diaphragm 122 opposite to the Z direction. The ultrasonic element 112 being provided at the position corresponding to the hollow 182 refers to a state in which the piezoelectric element 124 overlaps so as to be disposed in the hollow 182 when viewed from the Z direction.

The diaphragm 122 is sandwiched between the base 111 and the sealing substrate 114. Examples of the constituent material of the diaphragm 122 include a silicon-based material such as Si, an oxide-based material such as SiOx (0 < x < 3) or ZrOx (0 < x < 3), a metal-based material, and a resin-based material such as permanent resist. Further, the diaphragm 122 may be a stacked structure in which two or more layers of different constituent materials are stacked.

As illustrated in FIG. 5, the piezoelectric element 124 includes a first electrode 126, a piezoelectric film 127, and a second electrode 128 stacked in this order from the diaphragm 122 side. In the piezoelectric element 124, when a pulse wave voltage at a predetermined frequency is applied between the first electrode 126 and the second electrode 128, the piezoelectric film 127 expands and contracts. As a result, the diaphragm 122 vibrates at a frequency corresponding to the width W111 of the hollow 182 of the base 111 or the like, and ultrasonic waves are generated from the hollow 182 of the base 111 in the Z direction. Therefore, the base 111 and the ultrasonic element 112 function as an ultrasonic transducer. Since the piezoelectric element 124 as described above can be formed using a deposition process, manufacturing is easy and this contributes to cost reduction of the acoustic wave device 1.

A width W112 of the ultrasonic element 112 in a direction orthogonal to the Z direction is not particularly limited, but is preferably set to be smaller than the width W111. Accordingly, it is possible to efficiently generate the ultrasonic waves from the ultrasonic transducer.

The cap 113 illustrated in FIG. 4 is disposed in the Z direction of the base 111. That is, the cap 113 is provided on the surface of the base 111 opposite to the surface on which the ultrasonic element 112 is provided. The cap 113 closes the end of the hollow 182 in the Z direction. The ultrasonic wave generated from the ultrasonic transducer passes through the cap 113 and is transmitted in the Z direction.

The cap 113 has a plate shape, and has a first surface 165 and a second surface 166 in a front and back relationship with each other, and a hole 164 that opens to the first surface 165 and extends toward the second surface 166. The first surface 165 is a surface facing the hollow 182 of the base 111. The second surface 166 is a transmission surface from which the ultrasonic waves transmitted through the cap 113 are transmitted.

The hole 164 is a hole that does not penetrate the cap 113. Specifically, the hole 164 opens in the first surface 165 illustrated in FIG. 4, but does not open in the second surface 166.

The width of the hole 164 is W164. The width W164 is the maximum width of the hole 164 in the direction orthogonal to the Z direction. The width W164 is smaller than the width W112 of the ultrasonic element 112.

By providing the hole 164 having such a shape in the cap 113, it is possible to realize the acoustic wave device 1 that can efficiently transmit the ultrasonic waves generated by the ultrasonic transducer through the cap 113 and transmit the ultrasonic waves in the Z direction. That is, internal exposure is prevented by the cap 113, and thus it is possible to realize the acoustic wave device 1 that transmits the ultrasonic waves while suppressing attenuation of the ultrasonic waves generated by the ultrasonic transducer in the cap 113. Further, it is possible to receive the ultrasonic waves while suppressing the attenuation of the ultrasonic waves in the cap 113 and realize the acoustic wave device 1 having high reception sensitivity of the ultrasonic waves. As a result, it is possible to realize the ultrasonic sensor 15 having high detection accuracy of multi-feed.

In the acoustic wave device 1, the transmission surface of the ultrasonic waves is the second surface 166 of the cap 113, and thus the base 111 and the ultrasonic element 112 are not exposed. Therefore, it is possible to prevent paper dust falling off from the sheet P or the like from entering the acoustic wave device 1. Further, it is possible to prevent foreign matter or the like from adhering to the hollow 182, the ultrasonic element 112, or the like. Accordingly, it is possible to suppress attenuation of ultrasonic waves due to foreign matter or the like, deterioration of the ultrasonic element 112 due to moisture or the like, and the like. As a result, the ultrasonic sensor 15 having high reliability can be realized.

In the cap 113, as shown in FIG. 6, the hole 164 is not open to the second surface 166. Accordingly, the transmission surface of the ultrasonic waves in the transmitter 151 and the reception surface of the ultrasonic waves in the receiver 152 can be made flat (planar surfaces). Therefore, when the transmission surface of the ultrasonic wave is cleaned with a cleaning liquid or the like, the wiping property of foreign matter or the like is improved. As a result, the ultrasonic sensor 15 having excellent maintainability can be realized.

The acoustic wave device 1 may be disposed such that the second surface 166 is horizontal, but it is preferable that the second surface 166 is disposed to be inclined with respect to the horizontal plane. Accordingly, even when foreign matter or the like adheres to the second surface 166, the foreign matter or the like easily falls off naturally. In particular, when the second surface 166 is flat, such a tendency becomes remarkable.

It is considered that the above-described effects are obtained by the hole 164 of the cap 113. Specifically, it is considered that the configuration in which the width W164 of the hole 164 is optimized and the hole 164 does not open to the second surface 166 contributes to specific transmission of the ultrasonic waves. The structure that causes such a transmission phenomenon is also called an acoustic metamaterial. In the cap 113 illustrated in FIG. 4, it is considered that the air inside the hole 164 resonates according to the frequency of the acoustic waves, and thus the thin film located in the Z direction of the hole 164 (the portion between the hole 164 and the second surface 166 illustrated in FIG. 4) vibrates greatly, so that the acoustic waves are specifically transmitted.

When the acoustic wave device 1 is used for the receiver 152, it is possible to improve the reception sensitivity of the ultrasonic waves, improve the reliability, improve the maintainability, and the like.

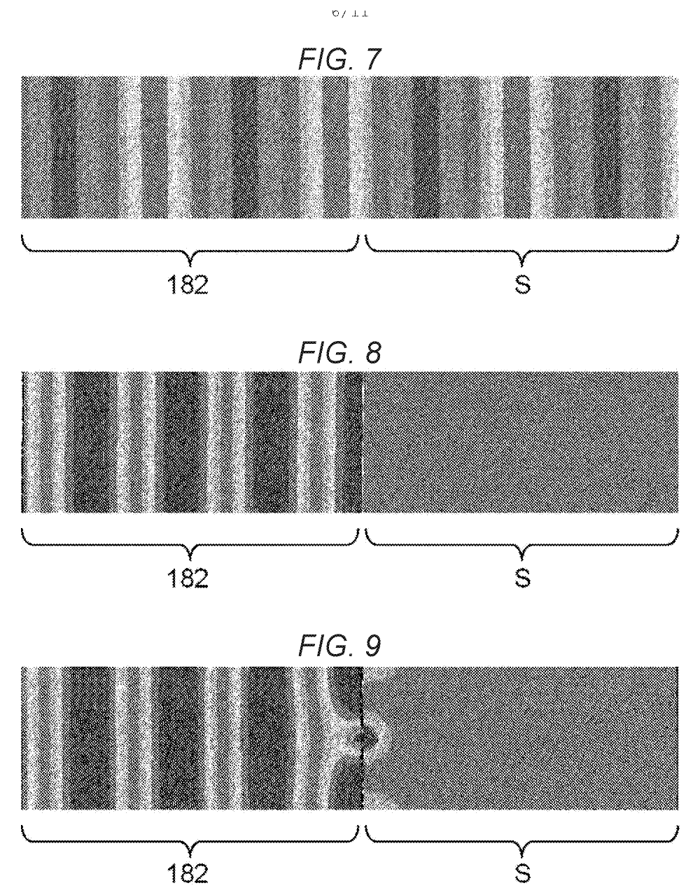

FIGS. 7 to 9 show results of simulations of propagation of ultrasonic waves in the hollow 182 of the acoustic wave device 1 and a space S located in the Z direction thereof. The stripe patterns shown in FIGS. 7 to 9 represent changes in pressure due to ultrasonic waves. That is, ultrasonic waves propagate in the regions with the stripe patterns, and ultrasonic waves do not propagate in the regions without the stripe patterns.

FIG. 7 shows the result of the simulation of a model in which the cap 113 is not present between the hollow 182 and the space S. The simulation shown in FIG. 7 illustrates that the ultrasonic waves generated in the hollow 182 are transmitted to the space S with little attenuation.

FIG. 8 shows the result of the simulation of a model in which the cap 113 having a through hole between the hollow 182 and the space S is provided. That is, in the model shown in FIG. 8, the through hole penetrating the cap 113 is provided instead of the hole 164 not open to the second surface 166 as shown in FIG. 4. The width of the through hole is smaller than the width of the ultrasonic element (not illustrated). The simulation shown in FIG. 8 illustrates that the ultrasonic waves generated in the hollow 182 hardly pass through the cap 113.

FIG. 9 shows the result of the simulation of a model in which the cap 113 having a hole that does not penetrate between the hollow 182 and the space S is provided. That is, the model shown in FIG. 9 is a model imitating the acoustic wave device 1 shown in FIG. 4. The width of the non-penetrating hole is smaller than the width of the ultrasonic element (not illustrated). The simulation shown in FIG. 9 illustrates that the ultrasonic waves generated in the hollow 182 are transmitted to the space S is illustrated.

The above simulation results support that the cap 113 having the width W164 smaller than the width W112 of the ultrasonic element 112 and having the hole 164 formed so as not to penetrate can specifically transmit the ultrasonic waves.

Examples of the constituent material of the cap 113 include a silicon-based material such as Si, an oxide-based material such as SiOx (0 < x < 3) or ZrOx (0 < x < 3), and a resin-based material such as permanent resist. The constituent material of the cap 113 may be a composite material using two or more of these materials.

The cap 113 may be a single-layer member or a stacked structure. The cap 113 shown in FIG. 4 is an example formed of a stacked structure. The cap 113 shown in FIG. 4 is formed of a stacked structure in which a first layer 161, a second layer 162, and a third layer 163 are stacked in this order from the base 111 side. The hole 164 penetrates the first layer 161, but does not reach the second layer 162 and the third layer 163. That is, the second layer 162 and the third layer 163 function as a lid of the hole 164. In FIG. 4, a portion of the second layer 162 and the third layer 163 located in the Z direction of the hole 164 is referred to as a cap C.

In FIG. 4, the thickness of the cap C is t. In the cap 113, the width W164 of the hole 164 and the thickness t of the cap C may be optimized according to the frequency of the transmitted ultrasonic waves. Accordingly, it is possible to efficiently transmit ultrasonic waves having a target frequency.

As a rough tendency, when the width W164 of the hole 164 is the same, the frequency of the ultrasonic waves transmitted through the cap 113 can be reduced by reducing the thickness t of the cap C or reducing the elastic modulus of the cap C. In contrast, when the thickness t and the elastic modulus of the cap C are the same, the frequency of the ultrasonic waves transmitted through the cap 113 can be reduced by increasing the width W164 of the hole 164. the optimum width W164 and thickness t can be found in consideration of the tendency. Further, the cap 113 capable of transmitting not only ultrasonic waves but also acoustic waves in the audible range can be realized.

As an example, in a case where the constituent material of the cap C is Si and the thickness t of the cap C is 1.5 μm, when the frequency of the ultrasonic waves transmitted through the cap 113 is y [kHz] and the width W164 of the hole 164 is x [μm], a relationship of y = (2 × 10⁷)x^{-1.987} is established therebetween. In this case, for example, in order to transmit ultrasonic waves having a frequency of 400 kHz, the width W164 of the hole 164 may be set to about 232 μm.

When the constituent material of the cap C is changed to SiO₂, a relationship of y = (2 × 10⁷)x^{-1.981} is established. Further, when the constituent material of the cap C is changed to resin, a relationship of y = 9571.9x^{-0.965} is established.

The thickness t of the cap C is preferably from 0.5 μm to 50 μm, and more preferably from 1 μm to 20 μm. When the thickness t of the cap C is within the above ranges, it is possible to realize the cap 113 having good transmittance in the ultrasonic range, in particular, good transmittance of ultrasonic waves having a frequency of about 40 kHz to 1 MHz suitable for detection of a distance, multi-feed, and the like.

The width W164 of the hole 164 is preferably smaller than the wavelength of the ultrasonic waves generated by the ultrasonic transducer (the base 111 and the ultrasonic element 112). According to the configuration, the cap 113 is the acoustic metamaterial, and the transmittance higher than the transmittance of the ultrasonic waves that the constituent material of the cap C originally has can be applied to the cap 113.

The width W164 of the hole 164 is preferably 50% or less, more preferably from 1% to 30% of the width W111 of the hollow 182. When the width W164 of the hole 164 is within the above ranges, it is possible to realize the cap 113 having good transmittance in the ultrasonic range, in particular, good transmittance of ultrasonic waves having a frequency of about 40 kHz to 1 MHz suitable for detection of a distance, multi-feed, and the like.

The width W164 of the hole 164 is preferably from 5 μm to 1000 μm, more preferably from 30 μm to 800 μm, and still more preferably from 50 μm to 600 μm.

The length L164 of the hole 164 in the Z direction is preferably from 20% to 99% of a thickness T of the cap 113, and more preferably from 50% to 95% of the thickness T. When the length L164 of the hole 164 is within the above ranges, it is possible to realize the cap 113 having good transmittance in the ultrasonic range, in particular, good transmittance of ultrasonic waves having a frequency of about 40 kHz to 1 MHz suitable for detection of a distance, multi-feed, and the like.

The length L164 of the hole 164 is preferably from 5 μm to 200 μm, and more preferably from 10 μm to 100 μm.

The constituent materials of the first layer 161, the second layer 162, and the third layer 163 are not particularly limited, and may be the same as or different from one another. In the latter case, the constituent material of the second layer 162 is preferably different from the constituent material of the first layer 161. Accordingly, the processing rates in the mechanical processing and the chemical processing can be made different between the first layer 161 and the second layer 162. As a result, it is possible to efficiently and easily perform processing for forming the hole 164 only in the first layer 161. In other words, when the hole 164 is formed, the second layer 162 and the third layer 163 can be left without being substantially processed, the thickness t of the cap C can be strictly controlled. Accordingly, it is possible to realize the acoustic wave device 1 in which the frequency of the ultrasonic waves transmitted through the cap 113 is strictly controlled.

For example, an SOI (Silicon on Insulator) substrate is preferably used for the above-described three-layer stacked structure. The SOI substrate is a substrate including the first layer 161 made of Si, the second layer made of SiO₂, and the third layer 163 made of Si. The SOI substrate is widely used, is easily available, and has stable quality. The SOI substrate is also a member that can be precisely processed by a semiconductor process. In particular, Si is easy to process by wet etching, and SiO₂ has a lower processing rate by wet etching than Si. Therefore, it is possible to inexpensively manufacture the cap 113 in which the thickness t of the cap C is strictly controlled depending on the thickness of the second layer 162 while the hole 164 having high dimensional accuracy can be formed by accurately processing the first layer 161. As a result, it is possible to realize the acoustic wave device 1 with suppressed variations in bandwidth of transmitted ultrasonic waves or the acoustic wave device 1 with suppressed variations in bandwidth of received ultrasonic waves.

Therefore, the hole 164 is preferably an etched hole. Accordingly, the hole 164 can be formed accurately in a short time. Thus, it is possible to easily realize the acoustic wave device 1 in which the accuracy of each of the width W164 and the length L164 of the hole 164 is high and the frequency of the transmitted ultrasonic waves is strictly controlled.

Hereinafter, an example of a method of forming the hole 164 by wet etching will be described.

First, a resist film having an opening corresponding to the shape of the hole 164 to be formed is formed on the surface of the first layer 161 of the SOI substrate.

Then, an etchant is supplied to the resist film. Accordingly, the first layer 161 and the etchant come into contact with each other in the opening, and the first layer 161 is etched in the Z direction. As a result, an etched hole having a shape corresponding to the opening can be formed. However, since the processing rate decreases when the etched hole extends and reaches the second layer 162, further extension is suppressed. As a result, the hole 164 penetrating the first layer 161, but not reaching the second layer 162 and the third layer 163 is obtained.

In the present embodiment, the cap 113 has the three-layer structure, but the third layer 163 may be omitted from the three layers. In this case, since only the second layer 162 serves as the cap C, it is easy to make the thickness t of the cap C thinner.

In the three-layer stacked structure, the constituent material of the first layer 161 and the constituent material of the third layer 163 are the same (Si). In this case, since the first layer 161 and the third layer 163 have the same thermal expansion coefficient, the warpage of the stacked structure can be suppressed as compared with the case without the third layer 163. As a result, the cap 113 with less warpage can be realized.

The number of holes 164 provided corresponding to one ultrasonic element 112 may be one or more. Since the attenuation of the ultrasonic waves in the cap 113 can be further suppressed by providing the plurality of holes 164 for one ultrasonic element 112, the sound pressure of the transmitted ultrasonic waves can be further increased. Further, the reception sensitivity of the ultrasonic waves in the acoustic wave device 1 can be further enhanced.

Examples of the shape of the hole 164 when viewed from the Z direction include a circular shape such as a perfect circle, an ellipse, or an oval, a polygonal shape such as a triangle, a quadrangle, a pentagon, or a hexagon, and other shapes. Among the shapes, a circular shape is preferable, and a perfect circle is more preferable. Accordingly, it is possible to suppress a decrease in mechanical strength of the cap 113 due to the hole 164. Further, the shape of an ultrasonic beam to be transmitted is improved, and ultrasonic waves hardly attenuated can be transmitted.

The arrangement of the plurality of holes 164 is not particularly limited, but may be a random arrangement and is preferably a regular arrangement at fixed intervals. Examples of the regular arrangement include a square lattice arrangement and a hexagonal lattice arrangement.

The sealing substrate 114 is a mounting member disposed on the surface of the ultrasonic element 112 opposite to the Z direction. In the sealing substrate 114 illustrated in FIG. 4, a recess 172 that is open to a surface facing the Z direction is formed. The piezoelectric element 124 is housed in the recess 172. According to the configuration, it is possible to favorably support the ultrasonic element 112 while securing the space for vibration of the ultrasonic element 112.

Examples of the constituent material of the sealing substrate 114 include a silicon-based material such as Si, an oxide-based material such as SiOx (0 < x < 3) or ZrOx (0 < x < 3), and a resin-based material such as permanent resist.

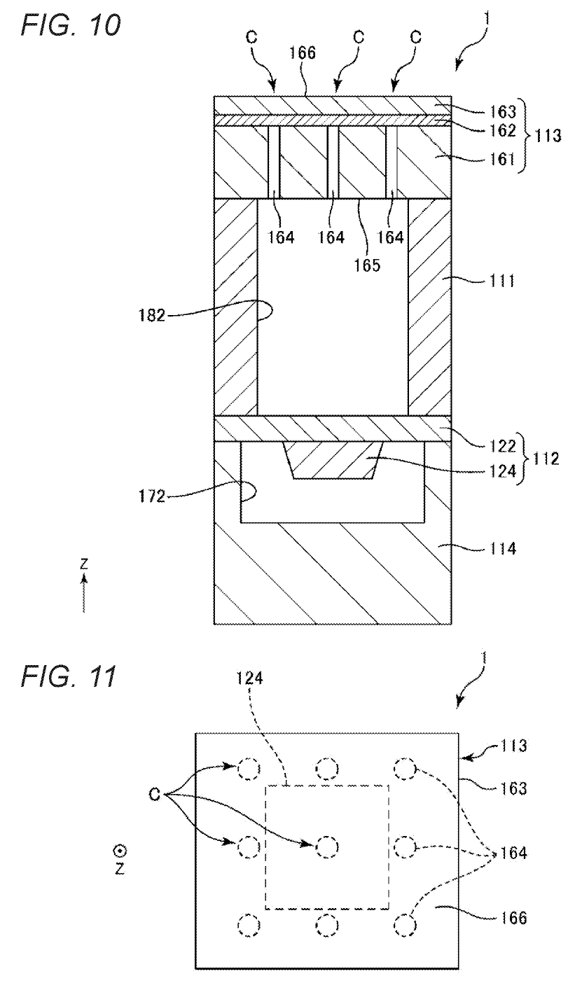

FIG. 10 is a cross-sectional view showing a modification of the acoustic wave device 1 in FIG. 4. FIG. 11 is a plan view of the acoustic wave device 1 shown in FIG. 10.

In the acoustic wave device 1 shown in FIGS. 10 and 11, nine holes 164 are provided corresponding to one ultrasonic element 112. That is, the nine holes 164 face one hollow 182. As shown in FIG. 11, the nine holes 164 are arranged in a square lattice. Accordingly, it is possible to realize the acoustic wave device 1 capable of transmitting an ultrasonic beam having higher sound pressure and less variations in sound pressure in a wider range.

The nine holes 164 may have different lengths, widths, shapes, and the like from one another, but are preferably the same. Accordingly, variations in frequency of the ultrasonic waves transmitted through the cap 113 are reduced, and the acoustic wave device 1 capable of transmitting ultrasonic waves having a small frequency distribution is obtained.

The number of holes 164 provided corresponding to one ultrasonic element 112 may be from two to eight, or may be ten or more.

Also in the modification, it is possible to obtain the same effects as those of the acoustic wave device 1 illustrated in FIG. 4, to increase the sound pressure of the transmitted ultrasonic waves, and to increase the reception sensitivity of the ultrasonic waves.

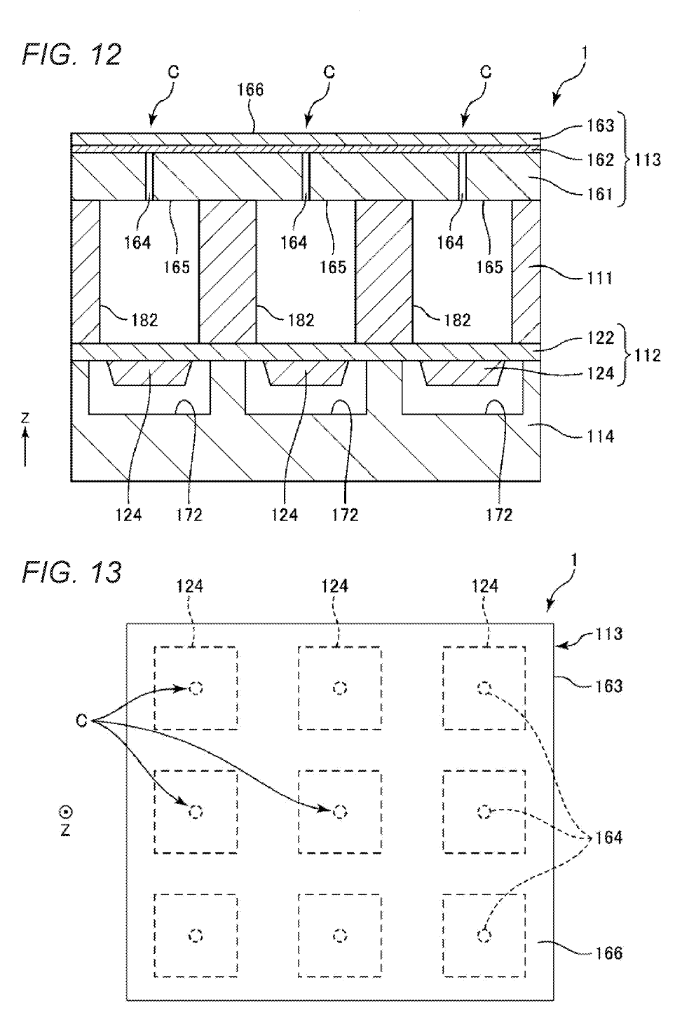

FIG. 12 is a cross-sectional view showing a modification of the acoustic wave device 1 in FIG. 4. FIG. 13 is a plan view of the acoustic wave device 1 shown in FIG. 12.

In the acoustic wave device 1 shown in FIGS. 12 and 13, nine holes 164 are provided corresponding to the nine ultrasonic elements 112. That is, the acoustic wave device 1 shown in FIGS. 12 and 13 corresponds to a device in which nine acoustic wave devices 1 shown in FIGS. 4 to 6 are arranged in a square lattice and are coupled to one another. Accordingly, it is possible to realize the acoustic wave device 1 capable of transmitting an ultrasonic beam having higher sound pressure. Further, in the plurality of ultrasonic elements 112, the frequencies and the transmission times of the ultrasonic waves can be made different. Accordingly, it is possible to transmit an ultrasonic beam having a plurality of frequencies or an ultrasonic beam in which a change in sound pressure is variously controlled.

As shown in FIG. 13, the nine ultrasonic elements 112 are arranged in the square lattice. Accordingly, it is possible to realize the acoustic wave device 1 capable of transmitting an ultrasonic beam having higher sound pressure and less variations in sound pressure in a wider range.

The number of ultrasonic elements 112 provided in one acoustic wave device 1 may be from two to eight, or may be ten or more.

Also in the modification, it is possible to obtain the same effects as those of the acoustic wave device 1 illustrated in FIG. 4, to increase the sound pressure of the transmitted ultrasonic waves, and to increase the reception sensitivity of the ultrasonic waves.

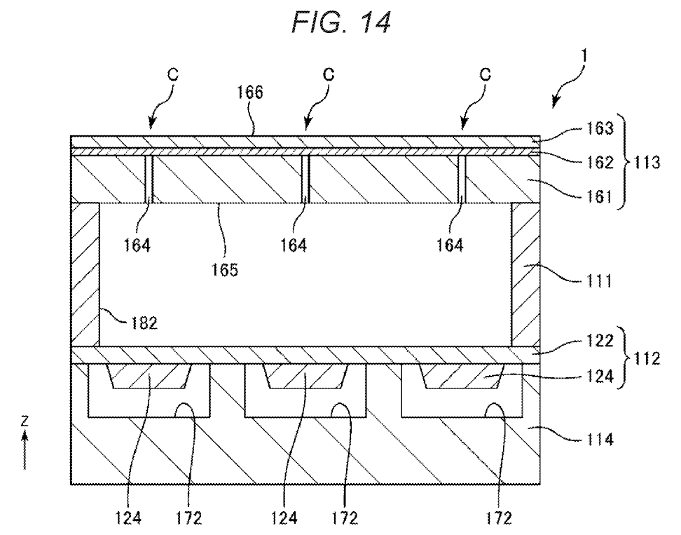

FIG. 14 is a cross-sectional view showing a modification of the acoustic wave device 1 in FIG. 12.

The acoustic wave device 1 shown in FIG. 14 is the same as the acoustic wave device 1 shown in FIG. 12 except that the configuration of the hollow 182 formed in the base 111 is different.

In the acoustic wave device 1 shown in FIG. 12, the number of hollows 182 formed in the base 111 is nine, which is the same as the number of ultrasonic elements 112. In contrast, in the acoustic wave device 1 shown in FIG. 14, there is one hollow 182. That is, the hollow 182 shown in FIG. 14 corresponds to a portion formed by coupling the nine hollows 182 shown in FIG. 12 to one another.

Also in the modification, it is possible to obtain the same effects as those of the acoustic wave device 1 shown in FIG. 12.

### Second Embodiment

Next, a wireless earphone will be described as an example of an electronic apparatus according to a second embodiment.

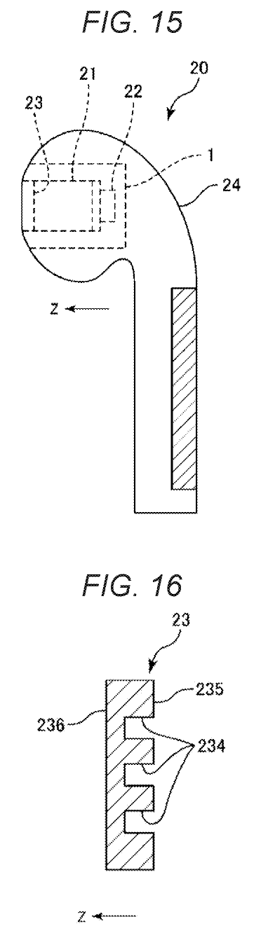

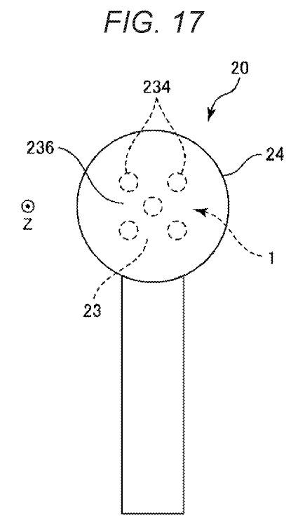

FIG. 15 is an external view showing a schematic configuration of a wireless earphone 20 as the electronic apparatus according to the second embodiment. FIG. 16 is a partially enlarged cross-sectional view of FIG. 15. FIG. 17 is an external view of the wireless earphone 20 shown in FIG. 15 when viewed from an angle different from that in FIG. 15.

Hereinafter, the second embodiment will be described. In the following description, differences from the first embodiment will be mainly described, and substantially the same items will be omitted. In FIGS. 15 to 17, the same configurations as those of the first embodiment have the same signs.

The wireless earphone 20 shown in FIGS. 15 to 17 is the same as the image scanner 10 shown in FIGS. 1 and 2 in that the acoustic wave device 1 is provided. The wireless earphone 20 is worn on a user's ear and transmits audible acoustic waves. Accordingly, a user can perceive sound such as music.

The wireless earphone 20 illustrated in FIG. 15 includes a housing 24 and the acoustic wave device 1 built in the housing 24. The acoustic wave device 1 shown in FIG. 15 includes a base 21, an acoustic wave element 22, and a cap 23. These configurations are the same as the configurations of the base 111, the ultrasonic element 112, and the cap 113 illustrated in FIG. 4 except for the following matters.

The base 21 and the acoustic wave element 22 function as a driver that generates acoustic waves in an audible range.

As illustrated in FIG. 16, the cap 23 has a plate shape, and includes a first surface 235 and a second surface 236 in a front and back relationship with each other, and a plurality of holes 234 that are open to the first surface 235 and extend toward the second surface 236. The configuration of the hole 234 is the same as that of the hole 164 described above. In the cap 23, the length, width, shape, and the like of the hole 234 are set so as to transmit the acoustic waves generated by the driver.

According to the configuration, it is possible to realize the acoustic wave device 1 capable of transmitting the acoustic waves generated by the driver efficiently through the cap 23 in the Z direction even though the holes 234 are not exposed to the outside. That is, it is possible to realize the acoustic wave device 1 that performs transmission while suppressing attenuation of the acoustic waves generated by the driver.

In the wireless earphone 20, as illustrated in FIG. 17, the second surface 236 of the cap 23 is an acoustic wave transmission surface. Therefore, it is possible to prevent foreign matter such as dust from entering the acoustic wave device 1. Further, since the acoustic wave transmission surface is flat, the wireless earphone 20 having excellent maintainability can be realized.

In the second embodiment described above, the same effects as those of the first embodiment can be obtained.

### Effects Exerted by Embodiments

As described above, the acoustic wave device 1 according to the embodiment includes the base 111, the ultrasonic element 112 (acoustic wave element), and the cap 113. The base 111 has the hollow 182. The ultrasonic element 112 is provided at the position corresponding to the hollow 182 of the base 111 and generates ultrasonic waves (acoustic waves). The cap 113 is provided on the surface of the base 111 opposite to the surface on which the ultrasonic element 112 is provided, and closes the hollow 182. Further, the cap 113 has the first surface 165 facing the hollow 182 and the second surface 166 located on the side opposite to the hollow 182 in the front and back relationship with each other, and the hole 164 that opens to the first surface 165 and extends toward the second surface 166. The width W164 of the hole 164 is smaller than the width W112 of the ultrasonic element 112, and the hole 164 does not penetrate the cap 113.

According to the configuration, it is possible to obtain the acoustic wave device 1 in which the entry of foreign matter can be suppressed because the internal exposure is prevented by the cap 113, and the transmitted and received acoustic waves are less likely to be attenuated because the ultrasonic waves can be efficiently transmitted through the cap 113.

In the acoustic wave device 1 according to the embodiment, the cap 113 may have the stacked structure in which the first layer 161 and the second layer 162 located closer to the second surface 166 side than the first layer 161 are stacked.

According to the configuration, by making the constituent materials of the first layer 161 and the second layer 162 different from each other, the hole that penetrates the first layer 161, but does not penetrate the second layer 162, that is, the hole 164 can be efficiently formed using, for example, an etching method or the like.

In the acoustic wave device 1 according to the embodiment, it is preferable that the hole 164 penetrates the first layer 161, but does not penetrate the second layer 162.

According to the configuration, the thickness t of the cap C can be strictly controlled depending on the thickness of the second layer 162. Therefore, it is possible to realize the acoustic wave device 1 in which the frequency of the acoustic waves transmitted through the cap 113 is strictly controlled.

In the acoustic wave device 1 according to the embodiment, the constituent material of the first layer 161 and the constituent material of the second layer 162 may be different from each other.

According to the configuration, the hole that penetrates the first layer 161, but does not penetrate the second layer 162, that is, the hole 164 can be efficiently formed using, for example, an etching method.

In the acoustic wave device 1 according to the embodiment, the stacked structure may further include the third layer 163 stacked on the side of the second layer 162 opposite to the first layer 161.

According to the configuration, for example, an SOI substrate can be used as the cap 113. Accordingly, it is possible to inexpensively manufacture the cap 113 in which the thickness t of the cap C is strictly controlled. As a result, it is possible to realize the acoustic wave device 1 with suppressed variations in bandwidth of transmitted ultrasonic waves or the acoustic wave device 1 with suppressed variations in bandwidth of received ultrasonic waves.

In the acoustic wave device 1 according to the embodiment, the constituent material of the first layer 161 and the constituent material of the third layer 163 may be the same as each other.

According to the configuration, the cap 113 with less warpage due to the difference in thermal expansion coefficient can be obtained.

In the acoustic wave device 1 according to the embodiment, the constituent material of the first layer 161 may be Si, and the constituent material of the second layer 162 may be SiO₂.

According to the configuration, Si is easily processed by wet etching, and the processing rate of SiO₂ by wet etching is lower than that of Si. Therefore, it is possible to inexpensively manufacture the cap 113 in which the thickness t of the cap C is strictly controlled depending on the thickness of the second layer 162 while the hole 164 having high dimensional accuracy can be formed by accurately processing the first layer 161.

In the acoustic wave device 1 according to the embodiment, the width W164 of the hole 164 is preferably smaller than the wavelength of the ultrasonic waves (acoustic waves).

According to the configuration, the cap 113 is the acoustic metamaterial, and the transmittance higher than the transmittance of the ultrasonic waves that the constituent material of the cap C originally has can be applied to the cap 113.

In the acoustic wave device 1 according to the embodiment, the length L164 of the hole 164 is preferably from 20% to 99% of the thickness T of the cap 113.

According to the configuration, it is possible to realize the cap 113 having good transmittance in the ultrasonic range, particularly, transmittance of ultrasonic waves having a frequency of about 40 kHz to 1 MHz suitable for detection of a distance, multi-feed, or the like.

In the acoustic wave device 1 according to the embodiment, the cap 113 may have a plurality of holes 164.

According to the configuration, since the attenuation of the ultrasonic waves in the cap 113 can be further suppressed, the sound pressure of the transmitted ultrasonic waves can be further increased. Further, the reception sensitivity of the ultrasonic waves in the acoustic wave device 1 can be further enhanced.

In the acoustic wave device 1 according to the embodiment, the hole 164 may be an etched hole.

According to the configuration, the hole 164 can be accurately formed in a short time. Thus, it is possible to easily realize the acoustic wave device 1 in which the accuracy of each of the width W164 and the length L164 of the hole 164 is high and the frequency of the transmitted ultrasonic waves is strictly controlled.

In the acoustic wave device 1 according to the embodiment, the ultrasonic element 112 (acoustic wave element) may include the diaphragm 122, the first electrode 126, the piezoelectric film 127, and the second electrode 128. The diaphragm 122 is provided on the side of the base 111 opposite to the cap 113 and covers the hollow 182. The first electrode 126 is provided on the side of the diaphragm 122 opposite to the hollow 182. The piezoelectric film 127 is provided on the side of the first electrode 126 opposite to the diaphragm 122. The second electrode 128 is provided on the side of the piezoelectric film 127 opposite to the first electrode 126.

According to the configuration, since the ultrasonic element 112 can be formed using a deposition process, manufacturing is easy and this contributes to cost reduction of the acoustic wave device 1.

The acoustic wave device 1 according to the embodiment includes the sealing substrate 114 provided on the side of the diaphragm 122 opposite to the base 111. The sealing substrate 114 may have the recess 172 that houses the ultrasonic element 112 (acoustic wave element).

According to the configuration, it is possible to favorably support the ultrasonic element 112 while securing the space for vibration of the ultrasonic element 112.

In the acoustic wave device 1 according to the embodiment, the acoustic waves may be ultrasonic waves.

According to the configuration, for example, the acoustic wave device 1 capable of measuring a distance and detecting an object can be realized.

The multi-feed detector (the ultrasonic sensor 15) according to the embodiment includes the transmitter 151 and the receiver 152. The transmitter 151 includes the acoustic wave device 1 according to the embodiment, and transmits ultrasonic waves. The receiver 152 includes the acoustic wave device 1 according to the embodiment, and receives ultrasonic waves. Further, in the ultrasonic sensor 15, the transmitter 151 and the receiver 152 are disposed with the conveyance path 130 of the sheet P (medium) in between. Furthermore, in the ultrasonic sensor 15, the ultrasonic waves are transmitted from the transmitter 151, the ultrasonic waves transmitted through the sheet P are received by the receiver 152, and the multi-feed of the sheets P is detected based on the signal intensity of the reception signal.

According to the configuration, it is possible to realize the ultrasonic sensor 15 having high detection accuracy of multi-feed and excellent reliability and maintainability.

The image scanner 10 as the electronic apparatus according to the embodiment includes the acoustic wave device 1 according to the embodiment.

According to the configuration, for example, it is possible to realize the image scanner 10 having excellent reliability and maintainability because entry of the foreign matter or the like into the acoustic wave device 1 is suppressed, and having high detection accuracy of multi-feed of the sheets P because the attenuation of the ultrasonic waves in the cap 113 is suppressed.

Although the acoustic wave device, the multi-feed detector, and the electronic apparatus according to the present disclosure have been described based on the illustrated embodiments, the present disclosure is not limited thereto.

For example, in the acoustic wave device, the multi-feed detector, and the electronic apparatus according to the present disclosure, each unit of the embodiment may be replaced with any configuration having the same function, or any configuration may be added to the embodiment.

The electronic apparatus according to the present disclosure can also be applied to electronic apparatuses other than the image scanner and the wireless earphone.

What is claimed is:

1. An acoustic wave device comprising:
a base having a hollow;
an acoustic wave element provided at a position corresponding to the hollow of the base and generating acoustic waves; and
a cap provided on a surface of the base opposite to a surface on which the acoustic wave element is provided and closing the hollow, wherein
the cap has a first surface facing the hollow and a second surface located on a side opposite to the hollow, and a hole that opens to the first surface and extends toward the second surface,
a width of the hole is smaller than a width of the acoustic wave element, and
the hole does not penetrate the cap.

2. The acoustic wave device according to claim 1, wherein
the cap has a stacked structure in which a first layer and a second layer located closer to the second surface than the first layer are stacked.

3. The acoustic wave device according to claim 2, wherein
the hole penetrates the first layer, but does not penetrate the second layer.

4. The acoustic wave device according to claim 3, wherein
the first layer is formed from a material different from that of the second layer.

5. The acoustic wave device according to claim 2, wherein
the stacked structure further includes a third layer stacked on a side of the second layer opposite to the first layer.

6. The acoustic wave device according to claim 5, wherein
the third layer is formed from the same material as the first layer.

7. The acoustic wave device according to claim 2, wherein
the first layer is formed from Si, and the second layer is formed from SiO₂.

8. The acoustic wave device according to claim 1, wherein
a width of the hole is smaller than a wavelength of the acoustic waves.

9. The acoustic wave device according to claim 1, wherein
a length of the hole is from 20% to 99% of a thickness of the cap.

10. The acoustic wave device according to claim 1, wherein
the cap includes a plurality of the holes.

11. The acoustic wave device according to claim 1, wherein
the hole is an etched hole.

12. The acoustic wave device according to claim 1, wherein
the acoustic wave element includes:
a diaphragm provided on a side of the base opposite to the cap and covering the hollow;
a first electrode provided on a side of the diaphragm opposite to the hollow;
a piezoelectric film provided on a side of the first electrode opposite to the diaphragm; and
a second electrode provided on a side of the piezoelectric film opposite to the first electrode.

13. The acoustic wave device according to claim 12, further comprising a sealing substrate provided on a side of the diaphragm opposite to the base, wherein
the sealing substrate has a recess that houses the acoustic wave element.

14. The acoustic wave device according to claim 1, wherein
the acoustic waves are ultrasonic waves.

15. A multi-feed detector comprising:
a transmitter including the acoustic wave device according to claim 14 and transmitting the ultrasonic waves; and
a receiver including the acoustic wave device according to claim 14 and receiving the ultrasonic waves, wherein
the transmitter and the receiver are disposed with a conveyance path of a medium in between, and
the ultrasonic waves are transmitted from the transmitter, the ultrasonic waves transmitted through the medium are received by the receiver, and multi-feed of the medium is detected based on signal intensity of a reception signal.

16. An electronic apparatus comprising the acoustic wave device according to claim 1.
